(19) United States
(12) Patent Application Publication
(10) Pub. No.: US 2025/0364585 A1
(43) Pub. Date: Nov. 27, 2025

(54) NEGATIVE ELECTRODE, ALL-SOLID-STATE BATTERY, METHOD FOR PREPARING ALL-SOLID-STATE BATTERY

(71) Applicants: Hyundai Motor Company, Seoul (KR); Kia Corporation, Seoul (KR)

(72) Inventors: Jong Jung Kim, Hwaseong (KR); Gyeong Jun Chung, Hwaseong (KR); Yoon Seon Kim, Hwaseong (KR); Sung Ju Cho, Hwaseong (KR); Hyun Geun Kwon, Hwaseong (KR); Seung Hwan Moon, Hwaseong (KR); Seul Gi Choi, Hwaseong (KR); Ju Yeon Lee, Hwaseong (KR); So Ri Lee, Hwaseong (KR)

(21) Appl. No.: 18/903,678

(22) Filed: Oct. 1, 2024

(30) Foreign Application Priority Data
May 21, 2024 (KR) 10-2024-0065970

(51) Int. Cl. H01M 10/0525; H01M 4/02; H01M 4/04; H01M 4/38; H01M 4/583; H01M 4/66; H01M 10/0562

(52) U.S. Cl. CPC H01M 10/0525; H01M 4/0404; H01M 4/382; H01M 4/386; H01M 4/583; H01M 4/662; H01M 10/0562; H01M 2004/027

(57) ABSTRACT

Provided is a negative electrode comprising a current collector with tensile strength ranging from about 1,000 MPa to 2,000 MPa and an active material layer. The current collector may be a Fe—Ni alloy foil containing nickel (Ni) from about 10 wt % to 60 wt % with an average grain size of less than 10 nm. An all-solid-state battery including this negative electrode and a method for its preparation are also described. The method involves stacking and isostatic pressing, with specific parameters for pressure, temperature, and time.

### CROSS-REFERENCE TO RELATED APPLICATION

This application claims under 35 U.S.C. § 119 (a) the benefit of Korean Patent Application No. 10-2024-0065970, filed in the Korean Intellectual Property Office on May 21, 2024, the entire contents of which are incorporated herein by reference.

### BACKGROUND

### Technical Field

The present disclosure relates to the field of battery technology, specifically to a negative electrode for all-solid-state batteries, including its composition and characteristics, and methods for preparing such batteries.

### Background

A lithium secondary battery employing a liquid electrolyte has been mainly used as a secondary battery employing lithium ions. The lithium secondary battery employing the liquid electrolyte including a negative electrode and a positive electrode separated from each other by a separator including polymer, and includes a liquid electrolyte. However, the lithium secondary battery employing the liquid electrolyte has various safety issues because the electrolyte is present in a liquid phase.

Accordingly, studies and researches have been performed on an all-solid-state battery employing, as an electrolyte, a solid electrolyte, instead of a liquid electrolyte. As the all-solid-state battery includes a negative electrode, a positive electrode, and a solid electrolyte, and all components of the all-solid-state battery may be solid, the all-solid-state battery may prevent safety issues caused by the liquid electrolyte, as compared to the lithium secondary battery employing the liquid electrolyte.

Regarding the use of such an all-solid-state battery, patent document 1 suggests a method in which multiple unit cells of the all-solid-state battery are stacked to improve the energy density of the all-solid-state battery.

In particular, patent document 1 discloses preparing of an all-solid-state battery by applying an isostatic pressing, to solve an issue in which a batter characteristic is not sufficiently exhibited when multiple unit cells of the all-solid-state battery are merely stacked.

However, when the isostatic pressing is applied to the preparing of the all-solid-state battery, pressure and time need to be applied up to the allowable limit of a device for the isostatic pressing to densify inner particles of an electrode and the interface between an electrode layer and an electrolyte layer, such that resistance is improved. In this case, a positive electrode tab or a negative electrode tab may be broken, which sharply increases a failure rate of the all-solid-state battery when the all-solid-state battery is prepared.

This problem arises during the implementation of the above-mentioned isostatic pressing process, as the unit cells have tabs protruding in the stacking direction, inevitably causing a level difference between the tabs. When the isostatic pressing process is carried out, anisotropic pressing inevitably occurs on the protruding tabs, causing them to bend in the direction of the plates, which is expected to result in fractures.

To solve the issue, patent document 2 discloses that a current collector protecting member serving as an extra insulating layer is applied to the protruding tab. As described above, according to patent document 2, when the isostatic pressing is performed with respect to the protruding tab by applying the current collector protecting member, the protruding tab may be prevented from being broken.

However, according to patent document 2, an additional process for separately removing the current collector protecting member is essentially required to electrically connect the unit cell to an external wire, after the isostatic pressing is finished.

In detail, according to patent document 2, when an all-solid-state battery is prepared by stacking multiple unit cells, the multiple unit cells need to be stacked after the current collector protecting member is removed. Accordingly, the isostatic pressing for each unit cell is required. In addition, as described above, when the all-solid-state battery is prepared by stacking the multiple unit cells formed in the above manner, as the current collector protecting member is removed, a gap is formed between the unit cells. Accordingly, when a laminated pack is performed after the multiple unit cells are stacked, the protruding tab may be partially cracked or broken.

In addition, according to patent document 2, the stack structure of the multiple unit cells is formed before the isostatic pressing is performed. Then, when the isostatic pressing is performed with respect to the stack structure of the multiple unit cells, the current collector protecting members are fixed while being fitted out the positive electrode tab and the negative electrode tab due to the protruding tab of the multiple unit cells. Accordingly, the current collector protecting member may be difficult to be removed.

### SUMMARY

The present disclosure has been made to solve the above-mentioned problems occurring in the prior art while advantages achieved by the prior art are maintained intact.

An aspect of the present disclosure is to prevent a protruding tab from being broken even if pressure and time are applied up to an allowable limit of a device for isostatic pressing without an additional protecting member, to densify inner particles of an electrode and the interface between an electrode layer and an electrolyte layer, such that resistance is improved, when the isostatic pressing is applied to the preparing of the all-solid-state battery to improve energy density of the all-solid-state battery.

In other words, the present disclosure is to provide a negative electrode having improved resistance and improved energy density, by preventing a protruding tab from being broken even if pressure and time are applied up to an allowable limit of a device for isostatic pressing to densify inner particles of an electrode and the interface between an electrode layer and an electrolyte layer, when the all-solid-state battery is prepared through the isostatic pressing.

In addition, the present disclosure is to provide an all-solid-state battery including the negative electrode.

Further, the present disclosure is to provide a method for preparing an all-solid-state battery.

The technical problems to be solved by the present disclosure are not limited to the aforementioned problems, and any other technical problems not mentioned herein will be clearly understood from the following description by those skilled in the art to which the present disclosure pertains.

According to the present disclosure, a negative electrode, an all-solid-state battery, and a method for preparing the all-solid-state battery are provided.

(1) The present disclosure provides a negative electrode including a negative electrode current collector, and a negative electrode active material layer formed on at least one surface of the negative electrode current collector, in which the negative electrode current collector has tensile strength ranging from 1,000 MPa to 2,000 MPa.

(2) The present disclosure provides the negative electrode including the negative electrode current collector which is a Fe—Ni alloy foil in (1).

(3) The present disclosure provides the negative electrode including the negative electrode current collector which is a Fe—Ni alloy foil containing Ni provided in an amount ranging from 10 wt % to 60 wt % in any one of (1) or (2).

(4) The present disclosure provides the negative electrode including the negative electrode current collector which is a Fe—Ni alloy foil having an average grain size ranging from more than 0 nm to 50 nm in any one of (1) to (3).

(5) The present disclosure provides the negative electrode including the negative electrode current collector which has an elongation ranging from 0% to 10% in any one of (1) to (4).

(6) The present disclosure provides the negative electrode including the negative electrode current collector which has a thickness ranging from 4 μm to 20 μm in any one of (1) to (5).

(7) The present disclosure provides the negative electrode including the negative electrode active material layer which includes at least one selected from the group consisting of a carbon-based negative electrode active material, a silicon-based negative electrode active material, and a lithium metal negative electrode active material in any one of (1) to (6).

(8) The present disclosure provides an all-solid-state battery including a negative electrode in any one of (1) to (7).

(9) The present disclosure provides the all-solid-state battery including a sulfide-based solid electrolyte in (8).

(10) The present disclosure provides a method for preparing an all-solid-state battery, which includes preparing a negative electrode by forming a negative electrode active material layer on at least one surface of a negative electrode current collector (S10), preparing a unit cell by stacking the negative electrode prepared in the S10, a solid electrolyte layer, and a positive electrode (S20), and performing isostatic pressing for the unit cell, which is prepared in the S20, in a stack direction (S30), in which the negative electrode current collector has tensile strength ranging from 1,000 MPa to 2,000 Mpa.

(11) The present disclosure provides the method for preparing the all-solid-state battery, in which the unit cell has a structure in which the negative electrode, the solid electrolyte layer, the positive electrode, the solid electrolyte layer, and the negative electrode are sequentially stacked in (10).

(12) The present disclosure provides the method for preparing the all-solid-state battery, in which the S30 is to perform ° C. the isostatic pressing after performing vacuum-laminated packing for the unit cell prepared in the S20 in (10) or (11).

(13) The present disclosure provides the method for preparing the all-solid-state battery, in which the isostatic pressing is performed under pressure ranging from 100 MPa to 1,000 MPa in any one of (10) to (12).

(14) The present disclosure provides the method for preparing the all-solid-state battery, in which the isostatic pressing is performed at a temperature ranging from 50° C. to 150° C. in any one of (10) to (13).

(15) The present disclosure provides the method for preparing the all-solid-state battery, in which the isostatic pressing is performed for a time ranging from 5 minutes to 120 minutes in any one of (10) to (14).

In some embodiments, a negative electrode includes a negative electrode current collector and a negative electrode active material layer formed on at least one surface of the negative electrode current collector. The negative electrode current collector has a tensile strength ranging from about 1,000 MPa to 2,000 MPa.

The negative electrode current collector may be a Fe—Ni alloy foil. It may contain nickel (Ni) provided in an amount ranging from about 10 wt % to 60 wt %. Alternatively, the Fe—Ni alloy foil may contain nickel (Ni) provided in an amount ranging from about 30 wt % to 60 wt %. The negative electrode current collector may have an average grain size ranging from more than about 0 nm to 50 nm or less than 10 nm. Additionally, the negative electrode current collector may have an elongation rate ranging from about 0% to 10% and a thickness ranging from about 4 μm to 20 μm.

The negative electrode active material layer may include at least one selected from the group consisting of a carbon-based negative electrode active material, a silicon-based negative electrode active material, and a lithium metal negative electrode active material.

An all-solid-state battery may include the negative electrode described. This all-solid-state battery may include a sulfide-based solid electrolyte.

A method for preparing an all-solid-state battery includes preparing a negative electrode by forming a negative electrode active material layer on at least one surface of a negative electrode current collector, preparing a unit cell by stacking the negative electrode, a solid electrolyte layer, and a positive electrode, and performing isostatic pressing for the unit cell in a stack direction. The negative electrode current collector may have a tensile strength ranging from about 1,000 MPa to 2,000 MPa.

The unit cell may have a structure in which a negative electrode, a solid electrolyte layer, a positive electrode, a solid electrolyte layer, and a negative electrode are sequentially stacked. The isostatic pressing for the unit cell may be performed after performing vacuum-laminated packing. The isostatic pressing may be performed under pressure ranging from about 100 MPa to 1,000 MPa, at a temperature ranging from about 50° C. to 150° C., and for a time ranging from about 5 minutes to 120 minutes. The negative electrode current collector may be a Fe—Ni alloy foil containing nickel (Ni) provided in an amount ranging from about 10 wt % to 60 wt % and having an average grain size ranging from more than about 0 nm to 50 nm.

In some embodiments, a negative electrode includes a negative electrode current collector and a negative electrode active material layer formed on at least one surface of the negative electrode current collector. The negative electrode current collector is a Fe—Ni alloy foil having tensile strength ranging from about 1,000 MPa to 2,000 MPa, contains nickel (Ni) provided in an amount ranging from about 30 wt % to 60 wt %, and has an average grain size of less than 10 nm.

As discussed, the method and system suitably include use of a controller or processer.

Unless indicated otherwise, tensile strength values are as determined at 25° C. and using a tensile strength analysis machine including a commercially available tensile strength analysis machine such as Zwick/Roell Z020 universal tension machine (Ulm, Germany).

### BRIEF DESCRIPTION OF THE DRAWINGS

The above and other objects, features and advantages of the present disclosure will be more apparent from the following detailed description taken in conjunction with the accompanying drawings:

FIGS. 1 and 2 are cross-sectional views of a unit cell according to an embodiment of the present disclosure.

### DETAILED DESCRIPTION

Hereinafter, the present disclosure will be described in more detail for the understanding of the present disclosure.

In this case, terms and words used in the present specification and the claims shall not be limitedly interpreted as commonly-used dictionary meanings, but shall be interpreted as to be relevant to the technical scope of the present disclosure based on the fact that the inventor may properly define the concept of the terms to explain the present disclosure in best ways.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although example embodiment is described as using a plurality of units to perform the example process, it is understood that the example processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present disclosure provides a negative electrode, an all-solid-state battery, and a method for preparing the all-solid-state battery.

According to an embodiment of the present disclosure, the negative electrode may be a negative electrode for an all-solid-state battery, and, specifically, a negative electrode for an all-solid-state battery, to which isostatic pressing is applied.

As described above in Background of the present disclosure, when the all-solid-state battery is prepared and when the isostatic pressing is applied, pressure and time need to be applied up to an allowable limit of a device for isostatic pressing to densify inner particles of an electrode and the interface between an electrode layer and an electrolyte layer, such that the resistance is improved. In addition, a unit cell, which is a target for the isostatic pressing, includes an uncoated part, protruding from a current collector for the installation of electrode tabs, and/or tabs (T, T′) provided on the uncoated part of the current collector in various manners while protruding. When the isostatic pressing is performed with respect to such a unit cell, anisotropic pressing is performed with respect to the uncoated part and/or the tabs T and T′ due to the step difference between the uncoated part and/or the tab T, which protrude, and the step difference between the uncoated part and/or the tab T′ which protrude, when viewed in the stack direction. Accordingly, the uncoated part and/or the tabs T and T′ may be broken. When the uncoated part and/or the tabs T and T′ may be broken as described above, an additional process for electrical connection needs to be performed to use the relevant unit cell as the all-solid-state battery. In addition, when even the current collector is affected by the breakage, the relevant unit cell may not be used.

However, according to an embodiment of the present disclosure, as a negative electrode includes a negative electrode current collector having tensile strength adjusted, the uncoated part and/or the tabs T and T′ may be prevented from being broken, even if the pressure and time are applied, up to the permissible limits of the device for the isostatic pressing, with respect to the unit cell including the uncoated part, which protrudes from the current collector and is used to provide a tab of an electrode, and/or tabs T and T′ provided on the uncoated part of the current collector in various manners while protruding.

According to an embodiment of the present disclosure, the negative electrode includes a negative electrode current collector, and a negative electrode active material layer formed on at least one surface of the negative electrode current collector, and the negative electrode current collector may have tensile strength ranging from 1,000 MPa to 2,000 MPa. Specifically, the negative electrode current collector has tensile strength of at least 1,000 MPa, at least 1,010 MPa, at least 1,020 MPa, at least 1,030 MPa, at least 1,040 MPa, at least 1,050 MPa, at least 1,060 MPa, at least 1,070 MPa, at least 1,080 MPa, at least 1,090 MPa, at least 1,100 MPa, at least 1,110 MPa, at least 1,120 MPa, at least 1,130 MPa, at least 1,140 MPa, at least 1,150 MPa, at least 1,160 MPa, at least 1,170 MPa, at least 1,180 MPa, at least 1,190 MPa, at least 1,200 MPa, at least 1,210 MPa, 1,220 MPa, 1,230 MPa, 1,240 MPa, 1,250 MPa, at least 1,260 MPa, at least 1,270 MPa, at least 1,280 MPa, at least 1,290 MPa, at least 1,300 MPa, or at least 1,310 MPa. In addition, the negative electrode current collector has tensile strength of at most 2,000 MPa, at most 1,950 MPa, at most 1,900 MPa, at most 1,850 MPa, at most 1,800 MPa, at most 1,750 MPa, at most 1,700 MPa, at most 1,650 MPa, at most 1,600 MPa, at most 1,590 MPa, at most 1,580 MPa, at most 1,570 MPa, at most 1,560 MPa, at most 1,550 MPa, at most 1,540 MPa, at most 1,530 MPa, at most 1,520 MPa, at most 1,510 MPa, at most 1,500 MPa, at most 1,490 MPa, at most 1,480 MPa, or at most 1,470 MPa. In general, a copper foil used for a current collector for a lithium secondary battery, particularly an all-solid-state battery has tensile strength ranging from about 300 MPa to about 400 MPa. An aluminum foil is the range from about 250 MPa to about 300 MPa, a nickel foil is in the range of about 700 MPa, and a SUS foil is in the range from about 450 MPa to about 800 MPa. However, the copper foil, the aluminum foil, the nickel foil, and the SUS foil are broken due to anisotropic pressing performed with respect to the uncoated part and/or the tabs T and T′, when the pressure and time are applied to the allowable limit of the device for isostatic pressing. On the contrary, for the negative electrode, as the tensile strength of the negative electrode current collector is adjusted, when the isostatic pressing is performed to prepare the all-solid-state battery, the uncoated part and/or the tabs T and T′ protruding may be prevented from being broken, even if the anisotropic pressing is performed with respect to the uncoated part and/the tabs T and T′.

According to an embodiment of the present disclosure, the negative electrode current collector may be a Fe—Ni alloy foil. As described above, when the Fe—Ni alloy foil is used as the negative electrode current collector, the condition of the tensile strength is satisfied. Accordingly, when the isostatic pressing is performed to prepare the all-solid-state battery, the uncoated part and/or the tabs T and T′ protruding may be prevented from being broken, even if the anisotropic pressing is performed with respect to the uncoated part and/the tabs T and T′. In addition, cell power and durability may be more improved. The Fe—Ni foil above may be prepared by an electroforming manner. In this case, the electroforming manner may be reproduced in a well-known manner as long as the electroforming manner is to prepare a Fe—Ni alloy foil suitable for the negative electrode current collector according to the present disclosure.

According to an embodiment of the present disclosure, the negative electrode current collector may be a Fe—Ni alloy foil containing 10 wt % and 60 wt % of nickel. For example, the negative electrode current collector may be a Fe—Ni alloy foil including nickel provided in an amount of at least 10 wt %, at least 11 wt %, at least 12 wt %, at least 13 wt %, at least 14 wt %, at least 15 wt %, at least 16 wt %, at least 17 wt %, at least 18 wt %, at least 19 wt %, at least 20 wt %, at least 21 wt %, at least 22 wt %, at least 23 wt %, at least 24 wt %, at least 25 wt %, at least 26 wt %, at least 27 wt %, at least 28 wt %, at least 29 wt %, at least 30 wt %, at least 31 wt %, at least 32 wt %, at least 33 wt %, at least 34 wt %, at least 35 wt %, at least 36 wt %, at least 37 wt %, at least 38 wt %, at least 39 wt %, or at least 40 wt %. In addition, the negative electrode current collector may be a Fe—Ni alloy foil including nickel provided in an amount of at most 60 wt %, at most 55 wt %, at most 50 wt %, at most 49 wt %, at most 48 wt %, at most 47 wt %, at most 46 wt %, at most 45 wt %, at most 44 wt %, at most 43 wt %, at most 42 wt %, at most 41 wt %, or at most 40 wt %. In this case, the Fe—Ni alloy may include iron in a residual amount excluding the nickel, and may include impurities inevitable according to a preparing method and process. When the negative electrode current collector is the Fe—Ni alloy containing nickel and iron in the above amount, durability may be more improved while preventing a decrease in cell power of the negative electrode current collector.

According to an embodiment of the present disclosure, the negative electrode current collector may be a Fe—Ni alloy foil having an average grain size ranging from greater than 0 nm to 50 nm. Specifically, the negative electrode current collector may be a Fe—Ni alloy foil having an average grain size greater than 0 nm, at least 1 nm, at least 2 nm, at least 3 nm, at least 4 nm, at least 5 nm, at least 6 nm, at least 7 nm, at least 8 nm, at least 9 nm, or at least 10 nm. In addition, the negative electrode current collector may be a Fe—Ni alloy foil having an average grain size of at most 50 nm, at most 45 nm, at most 40 nm, at most 35 nm, at most 30 nm, at most 25 nm, at most 20 nm, at most 19 nm, at most 18 nm, at most 17 nm, at most 16 nm, at most 15 nm, at most 14 nm, at most 13 nm, at most 12 nm, at most 11 nm, or at most 10 nm. When the average grain size of the Fe—Ni alloy is adjusted within the above range, durability may be further improved while satisfying the tensile strength of the negative electrode current collector described above.

According to an embodiment of the present disclosure, the negative electrode current collector may have an elongation ranging from 0% to 10%. For example, the negative electrode current collector may have an elongation of at least 0%, at least 0.5%, at least 1.0%, at least 1.5%, at least 2.0%, at least 2.5%, at least 3.0%, at least 3.5%, at least 4.0%, or at least 4.5%. In addition, the negative electrode current collector may have an elongation of at most 10.0%, at most 9.5%, at most 9.0%, at most 8.5%, at most 8.0%, at most 7.5%, at most 7.0%, at most 6.5%, or at most 6.0%. When the elongation of the negative electrode current collector is adjusted within the above range, mechanical properties of the negative electrode current collector may be further improved. In addition, during the isostatic pressing process for manufacturing all-solid-state batteries, along with the tensile strength, the uncoated part and/or the tab T protruding may be prevented from being broken even if the anisotropic pressing is performed with respect to the uncoated part and/or the tab T.

According to an embodiment of the present disclosure, the negative electrode current collector may have a thickness ranging from 4 μm to 20 μm. Specifically, the negative electrode current collector may have a thickness of at least 4 μm. In addition, the negative electrode current collector may have a thickness of at most 20 μm, at most 19 μm, at most 18 μm, at most 17 μm, at most 16 μm, at most 15 μm, at most 14 μm, at most 13 μm, at most 12 μm, at most 11 μm, at most 10 μm, at most 9 μm, at most 8 μm, at most 7 μm, or at most 6 μm. When the thickness of the negative electrode current collector is adjusted within the above range, the negative electrode current collector may be prevented from decreasing in mechanical properties, the all-solid-state battery having the thinner thickness may be prepared, and the energy density may be more improved.

According to an embodiment of the present disclosure, a solid electrolyte, a binder, or a conductive material may be optionally included, together with the negative electrode active material.

According to an embodiment of the present disclosure, the negative electrode active material may include a compound allowing reversible intercalation or deintercalation of a lithium ion. For example, a negative electrode active material layer may include at least one negative electrode active material selected from the group consisting of a carbon-based negative electrode active material, a silicon-based negative electrode active material, and a lithium metal negative electrode active material. More specifically, the negative electrode active material may include a carbon-based negative electrode active material, such as artificial graphite, natural graphite, graphitized carbon fiber, or amorphous carbon, a silicon-based negative electrode active material, such as Si, Si alloy, or SiOₓ (0<x<2), a metallic compound, such as Al, Sn, Pb, Zn, Bi, In, Mg, Ga, Cd, Si alloy, Sn alloy, or Al alloy, for alloying with lithium, a metal oxide, such as SnO₂, a vanadium oxide, a lithium vanadium oxide, for doping or dedoping for lithium ion; or a complex compound, such as an Si—C composite or a Sn—C composite, which includes the metallic compound and a carbonaceous material. Alternatively, the negative electrode active material may include any one or a mixture of two materials from among the above materials may be used. In addition, the negative electrode active material may include a lithium metal thin film which is a lithium metal negative electrode active material. In addition, the carbon-based negative electrode active material may include both low crystalline carbon and high crystalline carbon. The low crystalline carbon includes soft carbon and hard carbon, and the high crystalline carbon includes amorphous, plate, flake, spherical or fibrous natural graphite or artificial graphite, Kish graphite, pyrolytic carbon, mesophase pitch based carbonfiber, meso-carbon microbeads, mesophase pitches, and petroleum or coal tar pitch-divided coke.

According to an embodiment of the present disclosure, when the negative electrode active material layer includes a solid electrolyte, the solid electrolyte may be the same as or different from a solid electrolyte included in a solid electrolyte layer of the all-solid-state battery. Specifically, the solid electrolyte included in the negative electrode active material layer may be an azirodite-type sulfide-based solid electrolyte.

According to an embodiment of the present disclosure, when the negative electrode active material layer includes a binder, the binder is a component which aids in binding between components, such as a negative electrode active material, a solid electrolyte, and a conductive material, of the negative electrode active material layer. The binder may include at least one selected from the group of polyvinylidene fluoride-hexafluoropropylene copolymer (PVDF-co-HEP), polyvinylidenefluoride, polyacrylonitrile, polymethyl methacrylate, polyvinyl alcohol, carboxymethylcellulose (CMC), starch, hydroxypropylcellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butylene rubber (SBR), and fluorine rubber.

According to an embodiment of the present disclosure, when the negative electrode active material layer includes the conductive material, the conductive material may have conductivity without causing a chemical change in the all-solid-state battery. In detail, the conductive material may include at least one of the group consisting of graphite, such as natural graphite or artificial graphite, carbon black, such as acetylene black, Ketjen black, channel black, furnace black, lamp black, thermal black, a conductive fiber, such as a carbon fiber or metal fiber, carbon fluoride, metal powders, such as aluminum powders or nickel powders, a conductive whisker, such as zinc oxide, potassium titanate, conductive metal oxide, such as titanium oxide, and a conductive material such as a polyphenylene derivative.

The present disclosure provides an all-solid-state battery 100 including the negative electrode.

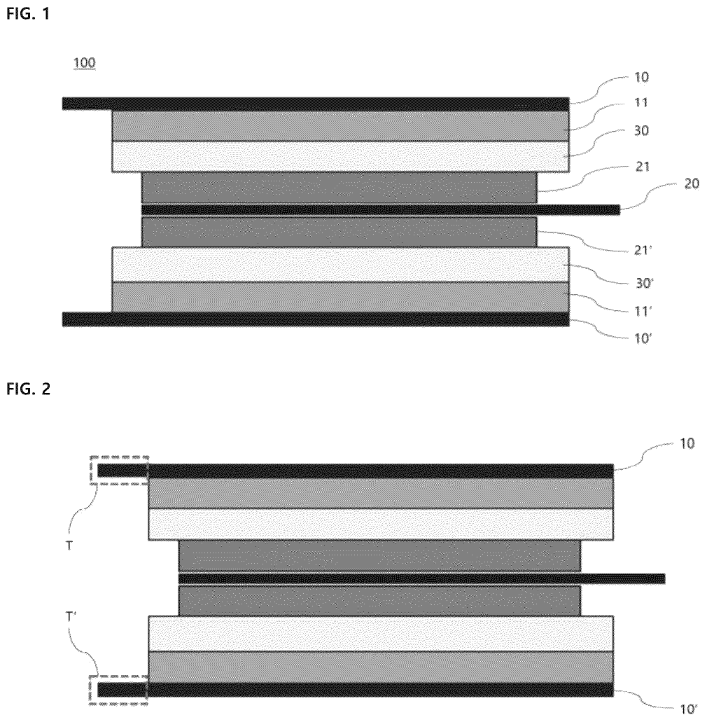

According to an embodiment of the present disclosure, the all-solid-state battery may include a negative electrode, a solid electrolyte layer, and a positive electrode. Specifically, the all-solid-state battery may include a unit cell. According to the present disclosure, the all-solid-state battery may refer to the unit cell, and may refer to the structure formed by stacking multiple unit cells. The unit cell may be a structure in which the negative electrode, the solid electrolyte layer, and the positive electrode sequentially stacked. Specifically, as illustrated in FIG. 1, the unit cell may be formed by sequentially stacking a first negative electrode current collector 10, a first negative electrode active material layer 11, a first solid electrolyte layer 30, a positive electrode active material layer 21, a positive electrode current collector 20, a second positive electrode active material layer 21′, a second solid electrolyte layer 30′, a second negative electrode active material layer 11′, and a second negative electrode current collector 10′. In this case, the first negative electrode current collector and the second negative electrode current collector may each independently correspond to the negative electrode current collector described above, and the first negative electrode active material layer and the second negative electrode active material layer may each independently correspond to the negative electrode active material layer described above. In addition, the first solid electrolyte layer and the second solid electrolyte layer may be the same or different from each other, the first negative electrode active material layer and the second negative electrode active material layer may be the same or different from each other, and the first negative electrode current collector and the second negative electrode current collector may also be the same as or different from each other.

According to an embodiment of the present disclosure, the positive electrode current collector 20 may include a metal having higher conductivity. The positive electrode current collector 20 may include various metals allowing the easy binding of the positive electrode active material layer as long as the various metals have no reactivity within the voltage range of the battery. Specifically, the negative electrode current collector may be, for example, stainless steel, aluminum, nickel, titanium, calcined carbon, or aluminum or stainless steel surface treated with carbon, nickel, titanium, or silver. In addition, the positive electrode current collector may typically have a thickness ranging from 3 μm to 500 μm, and may be used in various forms such as a film, sheet, foil, net, porous body, foam, or nonwoven fabric.

According to an embodiment of the present disclosure, the positive electrode active material layers 21 and 21′ may selectively include a solid electrolyte, a binder, and a conductive material, together with the positive electrode active material.

According to an embodiment of the present disclosure, the positive electrode active material may be a lithium metal oxide for intercalation and deintercalation with lithium. For example, the lithium metal oxide may include at least one metal selected from the group consisting of cobalt, manganese, nickel, and iron. More specifically, the lithium metal oxide may be at least one selected from the group consisting of LiCoO₂, LiNiO₂, LiMn₂O₄, LiCoPO₄, LiFePO₄, and LiNixMnyCozO₂ (x+y+z=1), and each lithium metal oxide may be doped and/or coated as necessary.

According to an embodiment of the present disclosure, when the positive electrode active material layer includes a solid electrolyte, the solid electrolyte above may be the same as or different from the solid electrolyte included in the solid electrolyte layer of the all-solid-state battery. Specifically, the solid electrolyte included in the positive electrode active material layer may be an azirodite-type sulfide-based solid electrolyte.

According to an embodiment of the present disclosure, when the positive electrode active material layer includes a binder, the binder is a component which aids in bonding between components, such as the positive electrode active material, the solid electrolyte, and a conductive material, of the positive electrode active material layer. The binder may include at least one selected from the group consisting of polyvinylidene fluoride-hexafluoropropylene copolymer (PVDF-co-HEP), polyvinylidenefluoride, polyacrylonitrile, polymethyl methacrylate, polyvinyl alcohol, carboxymethylcellulose (CMC), starch, hydroxypropylcellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butylene rubber (SBR), and fluorine rubber.

According to an embodiment of the present disclosure, when the positive electrode active material layer includes the conductive material, the conductive material may have conductivity without causing a chemical change in the all-solid-state battery. Specifically, the conductive material may be at least one material selected from the group consisting of graphite, such as natural graphite or artificial graphite, carbon black, such as acetylene black, ketjen black, channel black, furnace black, lamp black, or thermal black, a conductive fiber, such as a carbon fiber or a metal fiber, carbon fluoride, metal powders, such as aluminum powders or nickel powders, a conductive whisker, such as zinc oxide, potassium titanate, conductive metal oxide, such as titanium oxide, and a conductive material such as a polyphenylene derivative.

According to an embodiment of the present disclosure, the solid electrolyte layers 30 and 30′ may selectively include a binder together with a solid electrolyte.

According to an embodiment of the present disclosure, the solid electrolyte of the solid electrolyte layer may be the same as or different from the solid electrolyte which may be included in the negative electrode active material layer and/or the positive electrode active material layer described above. Specifically, the solid electrolyte included in the solid electrolyte layer may be at least one selected from the group consisting of a sulfide-based solid electrolyte, an oxide-based solid electrolyte, a chloride-based solid electrolyte, and a polymer solid electrolyte. More specifically, the solid electrolyte may be an azirodite-type sulfide-based solid electrolyte.

According to an embodiment of the present disclosure, when the solid electrolyte layer includes a binder, the binder is a component which aids in bonding between solid electrolytes, and may be at least one selected from the group of polyvinylidene fluoride-hexafluoropropylene copolymer (PVDF-co-HEP), polyvinylidenefluoride, polyacrylonitrile, polymethyl methacrylate, polyvinyl alcohol, carboxymethylcellulose (CMC), starch, hydroxypropylcellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butylene rubber (SBR), and fluorine rubber.

The present disclosure provides a method for preparing the all-solid-state battery such that the all-solid-state battery is prepared.

According to an embodiment of the present disclosure, the method for preparing the all-solid-state battery includes preparing the negative electrode by forming the negative electrode active material layer on at least one surface of the negative electrode current collector (S10), preparing the unit cell by stacking the negative electrode prepared in S10, the solid electrolyte layer, and the positive electrode (S20), and performing the isostatic pressing with respect to the unit cell formed in S20 in the stack direction (S30). The negative electrode current collector may have tensile strength ranging from 1,000 MPa to 2,000 MPa. According to the method for preparing the all-solid-state battery, since the description of the negative electrode, the solid electrolyte layer, and the positive electrode, and the unit cell has the same as the above description of the relevant components, the details thereof will be omitted in the method for preparing the all-solid-state battery. Unless otherwise specified, the negative electrode, the solid electrolyte layer, and the positive electrode, and the unit cell are the same as components described above.

According to an embodiment of the present disclosure, ‘S10’, which is a step to prepare the negative electrode, may be performed by forming the negative electrode active material layer on at least one surface of the negative electrode current collector. When the negative electrode active material layer is formed on the at least one surface of the negative electrode current collector, the negative electrode active material layer may be formed by coating negative electrode slurry, which is formed by mixing the negative electrode active material and a solvent, together with the solid electrolyte, the binder, or the conductive material, on the negative electrode current collector and drying the result. The content of each component for preparing the negative electrode slurry may be adjusted within a well-known range, based on the energy density and the process property of the all-solid-state battery. In addition, the coating may be performed within the well-known range. Specifically, the coating may be performed by applying the slurry on the negative electrode current collector through a doctor blade. The drying may be performed within the well-known range. In detail, the drying may be performed using a convection oven.

According to an embodiment of the present disclosure, ‘S20’, which is the step for preparing the unit cell to perform the isostatic pressing, may be performed by stacking the negative electrode, the solid electrolyte layer, and the positive electrode. In detail, ‘S20’ may be performed by sequentially stacking a first negative electrode current collector 10, a first negative electrode active material layer 11, a first solid electrolyte layer 30, a first positive electrode active material layer 21, a positive electrode current collector 20, a second positive electrode active material layer 21′, a second solid electrolyte layer 30′, a second negative electrode active material layer 11′, and a second negative electrode current collector 10′.

According to an embodiment of the present disclosure, ‘S30’, which is a step for performing the isostatic pressing for improving the energy density of the all-solid-state battery, is to perform the isostatic pressing with respect to the unit cell, which is prepared in S20, in the stack direction. According to the present disclosure, as the negative electrode current collector is applied, when the isostatic pressing in S30 is performed with respect to the unit cell prepared in S20, even if pressure and time need to be applied up to the allowable limit of a device for the isostatic pressing to densify inner particles of an electrode and the interface between an electrode layer and an electrolyte layer, such that resistance is improved, thereby preventing the protruding tabs T and T′ from being broken without an additional protective member.

According to an embodiment of the present disclosure, ‘S30’ may be performed by performing the isostatic pressing after forming a vacuum-laminated pack with respect to the unit cell prepared in S20. The vacuum-laminated pack may prevent a pressing medium from affecting a component in the unit cell, as the pressing medium is infiltrated into the unit cell, when the isostatic pressing is performed with respect to the unit cell. The inner part of the laminated pack is maintained in a vacuum state, thereby preventing a space other than the unit cell from being formed in the laminated pack, to guide pressure in the isostatic pressing to be uniformly transmitted to the unit cell. In the vacuum-laminated pack, the negative electrode current collectors 10 and 10′ positioned on at least one outmost surface of the unit cell may be positioned to be contact with an additional plate, and then the vacuum-laminated pack may be formed together with the plate.

According to an embodiment of the present disclosure, the isostatic pressing may be performed with pressure ranging from 100 MPa to 1,000 MPa. For example, the isostatic pressing may be performed at pressure of at least 100 MPa, at least 150 MPa, at least 200 MPa, at least 250 MPa, at least 300 MPa, at least 350 MPa, at least 400 MPa, or at least 450 MPa. In addition, the isostatic pressing may be performed at pressure of at most 1,000 MPa, at most 950 MPa, at most 900 MPa, at most 850 MPa, at most 800 MPa, at most 700 MPa, at most 650 MPa, at most 600 MPa, at most 550 MPa, or at most 500 MPa. When the isostatic pressing is performed within the above pressure range, the resistance may be improved by densifying the inner particles of the electrode and the interface between the electrode layer and the electrolyte layer.

According to an embodiment of the present disclosure, the isostatic pressing may be performed at a temperature ranging from 50° C. to 150° C. Specifically, the isostatic pressing may be performed at the temperature of at least 50° C., at least 55° C., at least 60° C., at least 65° C., at least 70° C., at least 75° C., at least 80° C., at least 85° C., or at least 90° C. In addition, the isostatic pressing may be performed at the temperature of at most 150° C., at most 145° C., at most 140° C., at most 135° C., at most 130° C., at most 125° C., at most 120° C., at most 115° C., at most 110° C., at most 105° C., or at most 100° C. When the isostatic pressing is performed within the temperature range, the unit cell may be prevented from being deformed and degraded due to the temperature, and the inner particles of the electrode and the interface between layers may be more highly densified.

According to an embodiment of the present disclosure, the isostatic pressing may be performed for a time ranging from 5 minutes to 120 minutes. For example, the isostatic pressing may be performed for a time of at least 5 minutes, at least 10 minutes, at least 15 minutes, at least 20 minutes, at least 25 minutes, or at least 30 minutes, and may be performed for a time of at most 120 minutes, at most 110 minutes, at most 100 minutes, at most 90 minutes, at most 80 minutes, at most 70 minutes, at most 60 minutes, at most 50 minutes, at most 40 minutes, or at most 30 minutes. When the isostatic pressing is performed within the time range, the productivity may be prevented from being degraded due to the isostatic pressing, and the inner particles of the electrode and the interface between layers may be more highly densified.

Hereinafter, examples of the present disclosure will be described in detail so that those skilled in the art may easily reproduce the present disclosure. However, the present disclosure may be implemented in various different forms and is not limited to the examples described herein.

### PREPARATION EXAMPLES

### Preparation Example 1

A Fe—Ni alloy foil current collector formed through an electroplating scheme and having an average grain size of 10 nm was prepared.

### Comparative Preparation Example 1

A Fe—Ni alloy foil current collector formed through an electroplating scheme and having an average grain size of 180 nm was prepared.

### Experimental Example 1

The Fe—Ni alloy foils prepared in Preparation Example 1 and Comparative Preparation Example 1 were measured in the average grain size and tensile strength through the following manner, and the result is shown in following table. 1.
Average grain size (nm): was calculated through the following Equation 1 (Scherrer equation) through XRD measurement.

FWHM=Kλ/LCOs θ [Equation 1]

In Equation 1, ‘L’ denotes a crystal size, ‘θ’ is a value obtained by dividing the analysis result, which is represented by 2θ, by ‘2’, ‘K’ is a constant value, and ‘λ’ is a wavelength used for XRD measurement.
Tensile strength (MPa): was measured using a tensile strength tester.

TABLE 1

| | Average grain | Tensile |
|---|---|---|
| Classification | size (nm) | strength (MPa) |
| Preparation Example 1 | 10 | 1,300 |
| Comparative preparation example 1 | 180 | 500 |

As illustrated in Table 1, even when the Fe—Ni alloy foil current collector is prepared through the electroplating scheme in the same manner, different tensile strengths are shown depending on the average grain sizes.

### Example and Comparative Example

### Example

The negative electrode, the positive electrode, and the solid electrolyte layer were prepared. Thereafter, as illustrated in FIG. 1, the unit cell was manufactured by stacking the solid electrolyte layer on each side of the positive electrode active material layer of the positive electrode so that one surface of the solid electrolyte layer is in contact with the positive electrode active material layer, and then stacking the negative electrode active material layer on the other surface of the solid electrolyte layer so that it is in contact with the solid electrolyte layer. After the unit cell is stacked on the plate, the vacuum-laminated pack was formed in the unit cell including the plate. After the unit cell, which is vacuum-laminated packed, is introduced into the device for the isostatic pressing, the isostatic pressing is performed under the pressure of 450 MPa, thereby preparing the all-solid-state battery.

### Comparative Example

According to an example, the all-solid-state battery was prepared by performing the same manner as Example 1, except that a nickel current collector having a thickness of 10 μm is used, instead of the negative electrode current collector prepared in Preparation example 1.

In this case, the nickel current collector showed tensile strength of 500 MPa measured in the same manner as in Experimental Example 1.

### Experimental Example 2

For the all-solid-state battery prepared in Examples and Comparative Examples, after the vacuum-laminated pack was removed, it was determined regarding whether the tab T, and T′ regions of the negative electrode current collector were broken.

Accordingly, it was recognized that the all-solid-state battery prepared according to an example was not broken in the tab region of the negative electrode current collector after the isostatic pressing was performed. However, it was recognized that the all-solid-state batteries prepared according to the comparative examples were broken in the tap regions of the negative current collectors.

### Experimental Example 3

A formation process was performed by charging all-solid-state batteries prepared according to examples and comparative examples to 4.25 V with the constant current of 0.05 C at the temperature of 25° C. and discharging the all-solid-state batteries to 2.5 V with the constant current of 0.05 C.

Subsequently, after charging the all-solid-state batteries to 4.25 V with a constant current of 0.2 C at the temperature of 25° C., and discharging the all-solid-state batteries to 2.5 V at the constant current of 0.2 C, a second cycle was performed. Then, discharge capacity and the average voltage were measured.

Then, after charging the all-solid-state batteries to 4.25 V with a constant current of 0.5 C at the temperature of 25° C., and discharging the all-solid-state batteries to 2.5 V at the constant current of 0.5 C, a sixth cycle was performed. The, discharge capacity and the average voltage were measured.

In addition, when charging up to 4.25 V with a constant current of 0.2 C at the temperature of 25° C., and then discharging to 2.5 V with a constant current of 0.2 C is considered as one cycle, charging and discharging were repeated for a total of 57 cycles. Then, after measuring a discharge capacity in eighth cycle and 57-th cycle, capacity retention rates were measured based on a discharge capacity in 57-th cycle, as compared to eighth cycle.

A discharge capacity, an average voltage, and a capacity retention rate measured in each step are showed in following Table 2.

TABLE 2

| | Second | Sixth | Eighth | Capacity |
|---|---|---|---|---|
| | cycles | cycles | cycles | retention |
| | (0.2 C) | (0.5 C) | (0.2 C) | rate (57-th |
| | discharge | discharge | discharge | cycle/eighth |
| | capacity | capacity | capacity | cycle) |
| Classification | (mAh/g) | (mAh/g) | (mAh/g) | (%) |
| example | 156.6 | 113.9 | 152.3 | 95.1 |
| Comparative Example | 152.2 | 103.8 | 148.6 | 94.0 |

As shown in table 2, it was recognized that cell power and the durability were improved in a current collector which is prepared according to Preparation example 1 of the present disclosure and having higher tensile strength is used as the negative electrode current collector, as compared to the comparative example which employs a nickel current collector as a negative electrode current collector.

As described above, according to the present disclosure, the negative electrode may have the improved resistance and the improved energy density, by preventing the protruding tab from being broken even if pressure and time are applied up to an allowable limit of the device for isostatic pressing, such that the isostatic pressing is performed up to the allowable limit of the device for the isostatic pressing, thereby densifying the inner particles of the electrode and the interface between the electrode layer and the electrolyte layer when the all-solid-state battery is prepared.

In addition, according to the present disclosure, as the all-solid-state battery including the negative electrode may be prepared, the all-solid-state battery may be prepared with improved resistance, excellent energy density, and higher production efficiency.

Hereinabove, although the present disclosure has been described with reference to example examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A negative electrode comprising:
a negative electrode current collector; and
a negative electrode active material layer formed on at least one surface of the negative electrode current collector,
wherein the negative electrode current collector has tensile strength ranging from about 1,000 MPa to 2,000 MPa.

2. The negative electrode of claim 1, wherein the negative electrode current collector is a Fe—Ni alloy foil.

3. The negative electrode of claim 1, wherein the negative electrode current collector is a Fe—Ni alloy foil containing nickel (Ni) provided in an amount ranging from about 10 wt % to 60 wt %.

4. The negative electrode of claim 1, wherein the negative electrode current collector is a Fe—Ni alloy foil containing nickel (Ni) provided in an amount ranging from about 30 wt % to 60 wt %.

5. The negative electrode of claim 1, wherein the negative electrode current collector is a Fe—Ni alloy foil having an average grain size ranging from more than about 0 nm to 50 nm.

6. The negative electrode of claim 1, wherein the negative electrode current collector is a Fe—Ni alloy foil having an average grain size ranging from more than about less than 10 nm.

7. The negative electrode of claim 1, wherein the negative electrode current collector has an elongation rate ranging from about 0% to 10%.

8. The negative electrode of claim 1, wherein the negative electrode current collector has a thickness ranging from about 4 μm to 20 μm.

9. The negative electrode of claim 1, wherein the negative electrode active material layer includes at least one selected from the group consisting of a carbon-based negative electrode active material, a silicon-based negative electrode active material, and a lithium metal negative electrode active material.

10. An all-solid-state battery comprising the negative electrode according to claim 1.

11. The all-solid-state battery of claim 10, wherein the all-solid-state battery includes a sulfide-based solid electrolyte.

12. A method for preparing an all-solid-state battery, the method comprising:
preparing a negative electrode by forming a negative electrode active material layer on at least one surface of a negative electrode current collector;
preparing a unit cell by stacking the negative electrode, a solid electrolyte layer, and a positive electrode; and
performing isostatic pressing for the unit cell in a stack direction,
wherein the negative electrode current collector has tensile strength ranging from about 1,000 MPa to 2,000 Mpa.

13. The method of claim 12, wherein the unit cell has a structure in which a negative electrode, a solid electrolyte layer, a positive electrode, a solid electrolyte layer, and a negative electrode are sequentially stacked.

14. The method of claim 12, wherein the isostatic pressing for the unit cell is performed after performing vacuum-laminated packing for the unit cell.

15. The method of claim 12, wherein the isostatic pressing is performed under pressure ranging from about 100 MPa to 1,000 MPa.

16. The method of claim 12, wherein the isostatic pressing is performed at a temperature ranging from about 50° C. to 150° C.

17. The method of claim 12, wherein the isostatic pressing is performed for a time ranging from about 5 minutes to 120 minutes.

18. The method of claim 12, wherein the negative electrode current collector is a Fe—Ni alloy foil containing nickel (Ni) provided in an amount ranging from about 10 wt % to 60 wt %.

19. The method of claim 12, wherein the negative electrode current collector is a Fe—Ni alloy foil having an average grain size ranging from more than about 0 nm to 50 nm.

20. A negative electrode comprising:
a negative electrode current collector; and
a negative electrode active material layer formed on at least one surface of the negative electrode current collector,
wherein the negative electrode current collector is a Fe—Ni alloy foil having tensile strength ranging from about 1,000 MPa to 2,000 MPa,
wherein the negative electrode current collector is a Fe—Ni alloy foil containing nickel (Ni) provided in an amount ranging from about 30 wt % to 60 wt %, and
wherein the negative electrode current collector has an average grain size of the Fe—Ni alloy foil of less than 10 nm.
